(19) United States
(12) Patent Application Publication
(10) Pub. No.: US 2016/0311135 A1
(43) Pub. Date: Oct. 27, 2016

(54) MOLDING METHODS AND SYSTEMS FOR ACHIEVING CLUSTERED EFFECT

(71) Applicant: GALA INDUSTRIES, INC., Eagle Rock, VA (US)

(72) Inventor: Matthew Jean TORNOW, Troutville, VA (US)

(21) Appl. No.: 15/133,616

(22) Filed: Apr. 20, 2016

Related U.S. Application Data
(60) Provisional application No. 62/150,510, filed on Apr. 21, 2015.

(51) Int. Cl. B29C 41/22; B29C 41/52; B29C 41/06

(52) U.S. Cl. CPC B29C 41/22; B29C 41/06; B29C 41/52; B29K 2105/251

(57) ABSTRACT

Systems, articles, and methods for rotational molding are disclosed herein. Specifically, materials in bags, or other containers, are placed into a mold for rotational molding. As the rotational molding process is carried out, the bags release the materials, enabling the materials to form a desired pattern on the surface of the resulting rotationally molded article. Optionally, a spreadable material may be applied to the inner mold wall to enhance the pattern on the surface of the molded article.

### CROSS-REFERENCE TO RELATED APPLICATIONS

This application claims the benefit, under 35 U.S.C. §120, of U.S. Provisional Patent Application No. 62/150,510, titled “MOLDING METHODS AND SYSTEMS FOR ACHIEVING CLUSTERED EFFECT,” filed Apr. 21, 2015, which is fully incorporated by reference.

### FIELD OF THE INVENTION

The presently disclosed subject matter relates to systems, articles, and methods for rotational molding, and more specifically, to systems, articles, and methods for rotational molding with pellets or other materials contained in bags.

### BACKGROUND

Several molding systems and methods are known, including systems and methods related to rotational molding. Briefly, rotational molding, or “roto molding,” is a type of molding that involves placing a material inside of a mold. The mold is then heated and rotated about one or more axes. As the heat from the mold softens and melts the material, the rotation distributes the material throughout the inside of the mold, causing the material to coat the inner wall of the mold. The mold is then cooled, causing the molded material to harden. The finished molded part can then be removed.

Typically, it is difficult to achieve a desired surface pattern on a rotationally molded part. This is especially true when the desired surface pattern is not uniform, such as with clustered (e.g., camouflage) designs. Achieving desired surface patterns can be difficult because, during conventional rotational molding processes, the rotation of the mold evenly distributes and mixes the materials inside of the mold, producing a uniform surface pattern.

Accordingly, there is a need for improved systems and methods to achieve desired surface patterns on rotationally molded parts, and embodiments of the present disclosure are directed to this and other considerations.

### SUMMARY

Briefly described, embodiments of the present disclosure can comprise a rotationally molded product formed with one or more bags to create a desired pattern on the product's surface. The bags may vary in size and/or shape to achieve the desired pattern, and can contain molding material(s) of various types and colors. Rather than placing molding material(s) directly into a mold, the molding materials may be first placed within bags, which are then placed into the mold. As the mold heats, the bags and their contained molding materials may also heat. Initially, the bags may prevent the molding material in the bag from mixing with other molding materials inside of the mold. When the bag material reaches its approximate melting point, the bag can give way, depositing the melted, partially melted, or unmelted molding material on the inner wall of the mold. The melted or partially melted molding material may be tacky, preventing it from freely dispersing in the mold. Accordingly, the molding material may stay in the general area where it was released from the bag, causing it to appear as a cluster or grouping on the final molded product. Thus, in this fashion, the use of one or more bags of molding material in rotational molding can enable a user to achieve a non-uniform surface pattern on the final molded part. In some embodiments, the non-uniform surface pattern can be a clustered (e.g., camouflage) pattern. Optionally, a spreadable material may be applied to the inner wall of the mold prior to molding to achieve the appearance of twigs, branches, leaves, crevices, cracks, stone appearance, mortar, and the like to further enhance the clustered pattern, and/or to provide a customized logo, design, or signature for display on the outer face of the article.

Further features of the disclosed design, and the advantages offered thereby, are explained in greater detail hereinafter with reference to specific embodiments illustrated in the accompanying drawings, wherein like elements are indicated by like reference designators.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a front view of a rotationally molded product in accordance with some embodiments of the present disclosure.

FIG. 2 shows a front view of bags used to form the rotationally molded product in accordance with some embodiments of the present disclosure.

FIG. 3 is a front view of a star-shaped bag in accordance with some embodiments of the present disclosure.

FIG. 4 shows a front view of a rotationally molded product having items resembling twigs on its surface in accordance with some embodiments of the present disclosure.

FIG. 5 is a front view of rotationally molded products formed with varying levels of molding materials inserted into the mold outside of bags in accordance with some embodiments of the present disclosure.

FIG. 6 is a top view of a mold containing bags and powder for forming a rotationally molded product in accordance with some embodiments of the present disclosure.

FIG. 7 is a top view of a rotationally molded product having pellet clusters in accordance with some embodiments of the present disclosure.

FIG. 8A is a front view of a putty pencil in accordance with some embodiments of the present disclosure.

FIG. 8B is a front view of a writing portion of a putty pencil in accordance with some embodiments of the present disclosure.

### DETAILED DESCRIPTION

To facilitate an understanding of the principles and features of the various embodiments of the invention, various illustrative embodiments are explained below. Although exemplary embodiments of the invention are explained in detail as being systems and methods related to rotational molding with bagged materials, it is to be understood that other embodiments are contemplated, such as embodiments employing other types of molding, or molding with materials not expressly mentioned in this disclosure. Accordingly, it is not intended that the invention is limited in its scope to the details of construction and arrangement of components set forth in the following description or examples. The invention is capable of other embodiments and of being practiced or carried out in various ways. Also, in describing the exemplary embodiments, specific terminology will be resorted to for the sake of clarity.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

The term “pattern” used herein, for example, can include any non-repeating or non-uniform pattern, such as a clustered design. While camouflage designs are described herein as an exemplary clustered design, the terms “clustered design,” “clustered pattern,” and “clustered effect” may be used herein to describe any pattern that includes one or more clusters or groupings of a color scheme.

The term “pellet” used herein, for example, can include, and be interchangeable with, micropellets or particulates. Such pellets/micropellets/particulates can take on a variety of shapes, and are typified by regular or irregular shaped discrete particles without limitation to their dimensions, including flakes, stars, spheres, cylindrical pellets, lenticular or disc-shaped pellets, chopped fibers, rubber crumb pellets, and/or other shapes. They can also be round, square, rectangular, triangular, pentagonal, hexagonal or otherwise geometric in cross-section, star-shaped or other decorative designs, and can be the same or different when viewed in a second cross-section perpendicularly to the first. It shall also be understood that the pellets do not have to be solid pieces, but may include particles defining openings or hollow shapes. Additionally, the pellets may include expanding agents, foaming agents, or volatiles, which may be partially or wholly expanded to produce low (or lower) bulk density particles.

The pellets can comprise many materials or combinations of materials including, but not limited to, polyethylene materials such as linear low density polyethylene (LLDPE), low density polyethylene (LDPE), medium density polyethylene (MDPE), and high density polyethylene (HDPE), polypropylenes, polyesters, polyamides, styrenic materials such as PS, ABS, and SAN, thermoplastic elastomers such as TPU, EPDM, and TPO, polycarbonates, PMMA, EVA, vinyls, plasticized and non-plasticized PVC, polyolefins, adhesives, asphalts and/or bitumen. In addition, these materials can cover a range of molecular weights, crystallinity, hardness, etc., which are in the solid phase and irrespective of color, additives (e.g., cross-linking agents, nucleating agents, foaming agents, coupling agents, compatabilizers, UV stabilizers, and antioxidants), fillers (e.g., mineral, organic, non-organic, treated, and un-treated fillers), clarity, and/or degree of transparency or opaqueness.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

To facilitate an understanding of the principles and features of this disclosure, various illustrative embodiments are explained below. In particular, various embodiments of this disclosure are described as systems and methods for rotational molding with bagged pellets. Some embodiments of the invention, however, may be applicable to other contexts, and embodiments employing these applications are contemplated.

As described above, one problem with conventional rotational molding process is that it is difficult to achieve a desired surface pattern on a rotationally molded part. This is especially true when the desired surface pattern is not uniform, such as with clustered designs. Achieving desired surface patterns can be difficult because, during conventional rotational molding processes, the rotation of the mold evenly distributes and mixes the materials inside of the mold, producing a uniform surface pattern.

To alleviate this problem, in some embodiments, rotational molding can be carried out with bagged molding materials. In other words, instead of placing the molding materials inside of the mold to flow freely, the molding materials can first be placed in bags, and the bags can be placed inside of the mold. In this manner, as the mold heats, the bags can heat, along with the molding material in the bags. In the meantime, the bags can prevent the molding material in the bag from mixing with other molding materials inside of the mold. When the bag material reaches its approximate melting point, the bag can give way, depositing the melted, partially melted, or unmelted molding material on the inner wall of the mold. The hot walls of the mold may melt or partially melt the molding material in the immediate area upon contact, thereby preventing at least a portion of the molding material, which may be tacky, from freely dispersing within the mold as it may have done in pellet form free of being in a bag. This may keep at least a portion of the molding material in the general area where it was released from the bag, causing a cluster or grouping of that molding material to appear in that area on the outer surface of the final molded part. Thus, in this fashion, the use of one or more bags of molding material in rotational molding can enable a user to achieve a non-uniform surface pattern on the final molded part. In some embodiments, the non-uniform surface pattern can be a clustered (e.g., camouflage) pattern.

In some embodiments, the rotational speed of the mold may be important to attain the desired clustered effect. For example, to help prevent the molding material from dispersing within the mold, slower mold rotation speeds may be used until a portion of the molding material has melted and adhered to the inner wall of the mold or until one or more of the bags have melted. In some embodiments, the mold rotation may be kept to a minimum (e.g., off or at a low setting) until a predetermined time or mold temperature (e.g., internal air temperature) threshold is reached. In one exemplary embodiment, it may be known that a particular molding material or bagging material begins to melt and adhere to the mold wall approximately 7 minutes into the molding process, and the mold rotation may be kept to a minimum until about 7.5 minutes into the molding process or another time corresponding to the known melting time.

In another exemplary embodiment, one or more sensors may be configured to measure the temperature within the mold, and send temperature measurements to a controller or to a display. In response to the mold temperature passing a threshold temperature, mold rotation may be activated. It is contemplated that the controller, which may comprise a computerized system and/or one or more processors configured to execute software instructions, may be configured to automatically activate and/or adjust rotation speeds of the mold in response to a temperature measurement or a time measurement from an internal or external clock reaching or exceeding a threshold. In some embodiments, the mold rotation speed may have an about 4:1 ratio between the major and minor axis of rotation.

In some embodiments, various molding materials can be included in the bags and/or outside of the bags. For example, in some embodiments, pellets can be placed in the bags. The pellets can be conventional pellets or micropellets, such as those produced by underwater or underfluid pelletizing machines. In some embodiments, micropellets can be pellets with a diameter approximately 1 mm or smaller, whereas conventional pellets have a larger diameter. The pellets may comprise various materials, as previously described herein, and can also have a variety of colors. In some embodiments, the pellets may vary in size and/or shape. It is contemplated that the pellet material, size, shape, and color may be tailored to a particular application or design of the part.

While the molding materials can be pellets, the molding materials can come in a variety of other forms as well. For example, the molding materials can comprise powders, flakes, shavings, clusters, and the like. In any given circumstance, the type of molding material best suited for a particular application can be employed. In some embodiments, multiple forms of molding materials may be used at the same time. In one exemplary embodiment, pellets can be placed in the bags while powders are included within the mold outside of the bags. In other embodiments, each bag can contain one type or form of molding material or a plurality of types or forms of molding materials. For example, each bag can contain only one type of polymer, or multiple types of polymers. Further, the molding materials may vary in properties (e.g., color, degree of transparency or opaqueness, etc.) from bag to bag and outside of the bags.

Any material or combinations of materials may be used as the bagging material to form the bags containing the molding materials or a portion thereof. For example, the bagging material can comprise many materials or combinations of materials including, but not limited to, polyethylene materials such as LLDPE, LDPE, MDPE, and HDPE, polypropylenes, polyesters, polyamides, styrenic materials such as PS, ABS, and SAN, thermoplastic elastomers such as TPU, EPDM, and TPO, polycarbonates, PMMA, EVA, vinyls, plasticized and non-plasticized PVC, polyolefins, adhesives, asphalts and/or bitumen. In addition, these materials can cover a range of molecular weights, crystallinity, hardness, etc., which are in the solid phase and irrespective of color, additives (e.g., cross-linking agents, nucleating agents, foaming agents, coupling agents, compatabilizers, UV stabilizers, and antioxidants), fillers (e.g., mineral, organic, non-organic, treated, and un-treated fillers), clarity, and/or degree of transparency or opaqueness. In some embodiments, the bagging material(s) can be identical or have similar properties to one or more of the molding materials. Further, in other embodiments, the bag material can be selected and changed based on a particular application. Factors involved in selecting the preferred bag material can include the melt temperature and/or melt flow index of the bag material, the size and thickness of the bag, the base polymer and/or formulation of the bag, the melt temperature of the molding material, the operating temperature of the mold, and/or other processing conditions.

In some embodiments, the molding materials included in the bags can have a similar melting temperature, or the same melting temperature, as the bag material. This can help ensure that when the bag material melts, and the bag gives way, the molding material is also melted or partially melted. As previously described herein, this can cause the molding material to stay in the general area where it was released from the bag, enabling a user to achieve a desired surface pattern

In addition, as previously described herein, more than one bag can be placed in the mold in some embodiments. Each bag can contain molding materials of one color or molding materials of a plurality of colors. In this manner, each bag can add a different color or pattern of colors to the surface pattern of the final molded part.

In some embodiments, to achieve a desired surface pattern, the bags in the mold can vary in shape and/or size. Thus, some bags can be larger than other bags. Moreover, one or more bags can be shaped to form a desired pattern on the surface of the final molded part. For example, if a camouflage pattern with leaf-like shapes is desired, one or more bags can be in the shape of a leaf. Moreover, in cases where a particular color pattern is desired, or when certain shapes and/or colors are desired to be near each other, a plurality of bags can be attached. Thus, attaching bags can help a user to manipulate the appearance of the final surface pattern. In other embodiments, the bagging material may be perforated to allow gas (e.g., internal air within the mold) to enter the bags during molding. In further embodiments, the bags may be filled with air or an inert gas (e.g., nitrogen) or vacuumed to achieve a desired effect.

In one exemplary aspect, according to some embodiments, a method of rotational molding may include providing one or more first bags in a mold. The one or more first bags may contain at least a first molding material. The method may also include providing one or more second bags in a mold. The one or more second bags may contain at least a second molding material. The first and second molding materials may each have a different visual material property. The method may further include melting, as the mold rotates, the one or more first bags and the one or more second bags to release the first molding material from the one or more first bags and the second molding material from the one or more second bags.

In further embodiments, the method may also include causing a first portion of the released first molding material to adhere to an inner wall of the mold proximate a first immediate release area of the first molding material from the one or more first bags. The method may further include causing a first portion of the released second molding material to adhere to the inner wall of the mold proximate a second immediate release area of the second molding material from the one or more second bags. Further, the method may include causing a second portion of the released first molding material and a second portion of the released second molding material to mix before adhering to another area of the inner wall of the mold to achieve a non-uniform surface pattern in the resulting molded part.

In some embodiments, the one or more first bags may include a first bag having a first inner void shape and a second bag having a second inner void shape different than the first inner void shape. At least one of the first and second inner void shapes may be based on the non-uniform surface pattern in the resulting molded part.

In other embodiments, the method may also include providing at least a third molding material in the mold. The first, second, and third molding materials may each have a different visual material property. In some exemplary embodiments, the method may also include causing a first portion of the released first molding material to adhere to an inner wall of the mold proximate a first immediate release area of the first molding material from the one or more first bags. The method may further include causing a first portion of the released second molding material to adhere to the inner wall of the mold proximate a second immediate release area of the second molding material from the one or more second bags. Further, the method may include causing a second portion of the released first molding material and a second portion of the released second molding material to mix with at least a portion of the third molding material before adhering to another area of the inner wall of the mold to achieve a non-uniform surface pattern in the resulting molded part. In other exemplary embodiments, providing the third molding material in the mold may include providing one or more third bags containing the third molding material in the mold. In some embodiments, the first and second molding materials may include one or more of pellets and micropellets, and the third molding material include one or more of powders, flakes, shavings, pellets, micropellets, and clusters. In further exemplary embodiments, providing the third molding material in the mold may include depositing the third molding material in the mold after the first portion of the released first molding material adheres to the inner wall of the mold proximate the first immediate release area.

In some embodiments, the first molding material may have a first visual material property and the second molding material may have a second visual material property differing from the first material property. For example, the first visual material property may include one or more of a first color and a first degree of transparency and the second visual material property may include one or more of a second color and a second degree of transparency.

In other embodiments, the method may also include rotating the mold at a first rotational speed before the first portion of the released first molding material adheres to the first immediate release area of the inner wall of the mold, and rotating the mold at a second rotational speed after the first portion of the released first molding material adheres to the first immediate release area of the inner wall of the mold.

In further embodiments, the method may also include measuring a mold temperature within the mold, and determining when the measured mold temperature exceeds a predetermined temperature threshold. Based on the determination, the rotational speed of the mold may be adjusted.

In some embodiments, the method may also include determining when a molding process duration exceeds a predetermined time threshold, and adjusting a rotational speed of the mold based on the determination.

In further embodiments, the method may also include providing one or more mixed bags in the mold. The one or more mixed bags may contain at least the first molding material and the second molding material.

In other embodiments, the one or more first bags may include a first bag having a first size and a second bag having a second size different than the first size.

In further embodiments, providing the one or more first bags in a mold may further include attaching a first bag of the one or more first bags to a second bag of the one or more first bags and providing the attached first and second bags in the mold.

In some embodiments, at least one of the one or more first bags may be perforated.

In other embodiments, the method may also include one or more of directing a fluid into at least one of the one or more first bags before providing the one or more first bags in the mold, and suctioning a fluid from at least one of the one or more first bags before providing the one or more first bags in the mold.

In other embodiments, a molded part may be formed by the method. The molded part may include an outermost layer having a non-uniform surface pattern with one or more concentrated areas of the first molding material, one or more concentrated areas of the second molding material, and one or more mixed areas of at least the first molding material and the second molding material. The first and second molding materials may each have a different visual material property.

In another aspect, according to some embodiments, a method of rotational molding may include providing one or more first bags in a mold, the one or more first bags containing at least a first molding material. The first molding material may have a first visual material property. The method may also include providing one or more second bags in a mold. The one or more second bags may contain at least a second molding material in the mold. The second molding material may have a second visual material property differing from the first visual material property of the first molding material. The method may further include melting, as the mold rotates, the one or more first bags to release the first molding material from the one or more first bags. The method may also include determining when at least one of the one or more first bags and the one or more second bags have melted. Based on the determination, the rotational speed of the mold may be adjusted.

In further embodiments, the first visual material property may include one or more of a first color and a first degree of transparency, and the second visual material property may include one or more of a second color and a second degree of transparency.

In yet another aspect, according to some embodiments, a method of rotational molding may include applying a spreadable material to the inner wall of the mold. The spreadable material may be configured to transfer to the surface of the final molded part when the mold is heated. The spreadable material may be provided to the inner wall via a spreadable material instrument. The method may also include providing one or more first bags in a mold. The one or more first bags may contain at least a first molding material. The method may also include providing one or more second bags in a mold. The one or more second bags may contain at least a second molding material. The first and second molding materials may each have a different visual material property. The method may further include melting, as the mold rotates, the one or more first bags and the one or more second bags to release the first molding material from the one or more first bags and the second molding material from the one or more second bags.

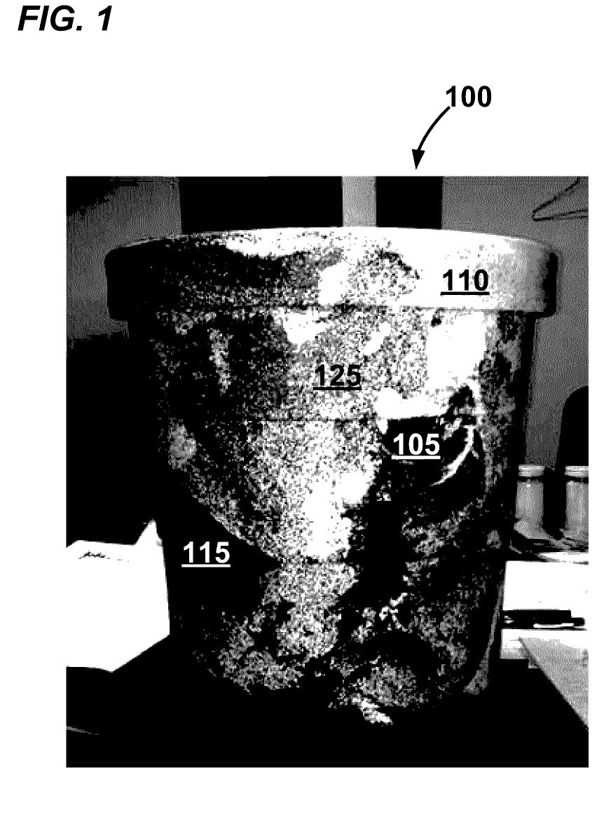

FIG. 1 depicts a final molded part 100 in accordance with some embodiments described herein. As can be seen, a final molded part can have a non-uniform surface pattern. Area 105 was formed by red molding materials in a first bag, area 110 was formed by white molding materials in a second bag, area 115 was formed by blue molding materials in a third bag, and area 120 was formed by brown molding materials in a fourth bag. In addition, area 125 was formed by free-flowing molding materials that mixed from a plurality of bags. Other molding materials placed inside or outside of bags may have been used. As can be seen, when the bags give way, and the molding materials are deposited on the inner wall of the mold, the molding materials may interact to form a non-uniform surface pattern. Despite the bright colors used in this surface pattern, it resembles a camouflage pattern.

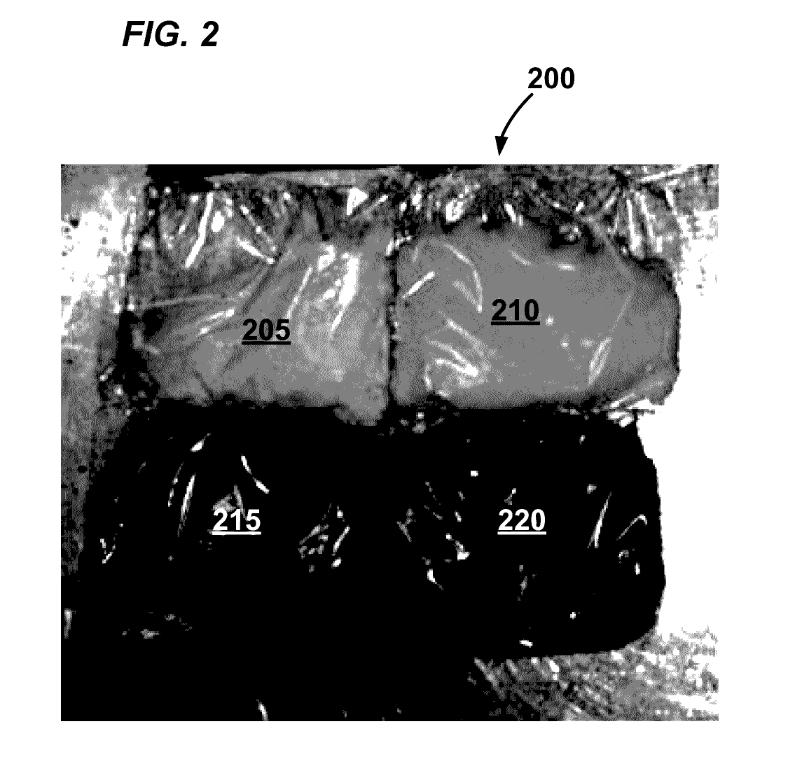

FIG. 2 shows bags 200 in accordance with some embodiments described herein. As shown, the bags may vary in volume, size, shape, and/or color. Bag 205 contains white molding materials, such as pellets, while bags 210, 215, and 220 contain yellow, green, and red molding materials, respectively. Other molding materials may be used. Bag 205 is the smallest of the bags 200, with bag 210 being larger and bags 215 and 220 being the largest. In some embodiments, the bags 200 may be attached to one another. For example, the bags 200 may be attached in a particular shape or pattern to produce a desired design in a final molded part. In other embodiments, the bags 200 may be separate, allowing them to move independently within the mold. Further, when separate, the bags 200 may be introduced into the mold at different times or temperatures.

The bags 200 may contain like material or different material. For example, each bag may contain material of a different color, shape, form, melt flow, density, opacity, polymer etc. In some embodiments, the molding materials may include any rotomolding material (e.g., powder, pellets, micropellets, hollow pellets, crumb rubber pellets, flakes, etc.).

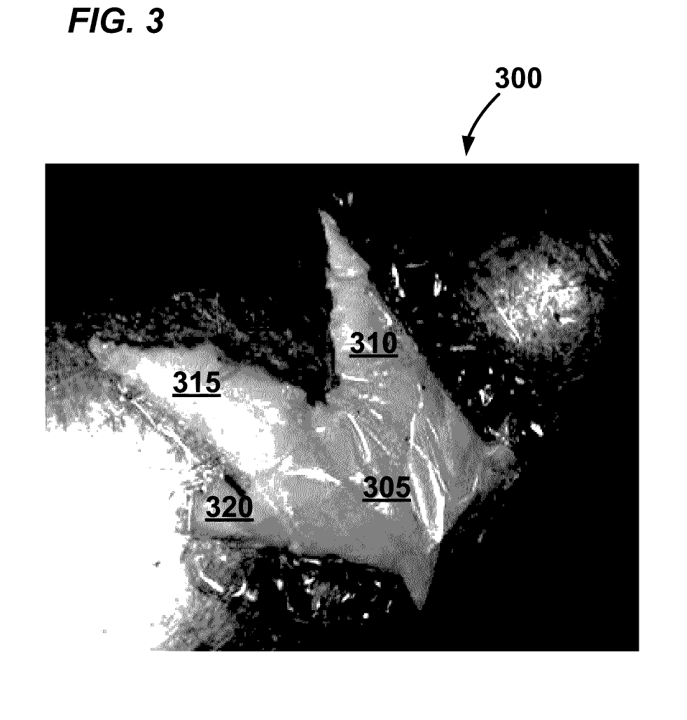

In some embodiments, the bags 200 may take on various shapes. For example, as shown in FIG. 3, a bag 300 may have an inner void or cavity that is star shaped and includes a body 305 and a plurality of fingers 310, 315, and 320. That is, regardless of the outer shape of the bag 300, the inner void within the bag 300 that is configured to receive materials held with the bag 300 may be shaped as desired (e.g., star shaped with a body 305 and a plurality of fingers 310, 315, and 320). It is contemplated that, in some embodiments, the exterior of the bag 300 may have the same shape as the inner void within the bag 300. To form the star shape, a bagging material 325 may allow the molding materials to fill the inner void in the designated shape and contain the molding materials within the inner void. In some embodiments, as shown, the bagging material 325 may be clear, allowing an operator to see the inner contents of the bag 300. In other embodiments, the bagging material 325 may be colored. Further, the size and/or shape formed by the bagging material 325 and/or the inner void of the bag 300 may vary as desired. For example, the bagging materials 325 may form a bag with an inner void that resembles leaves, branches, bushes, brush, pine needles, sand, dirt, grass, and the like.

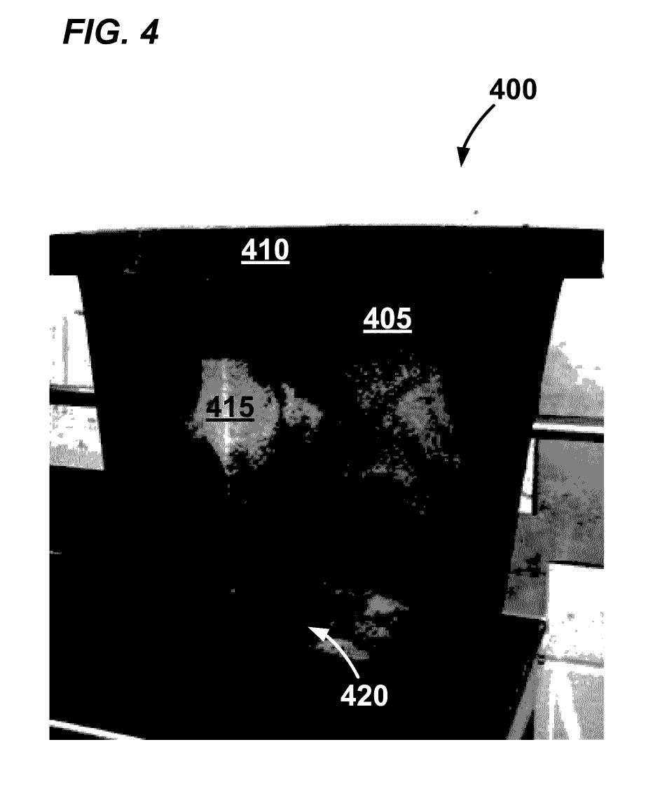

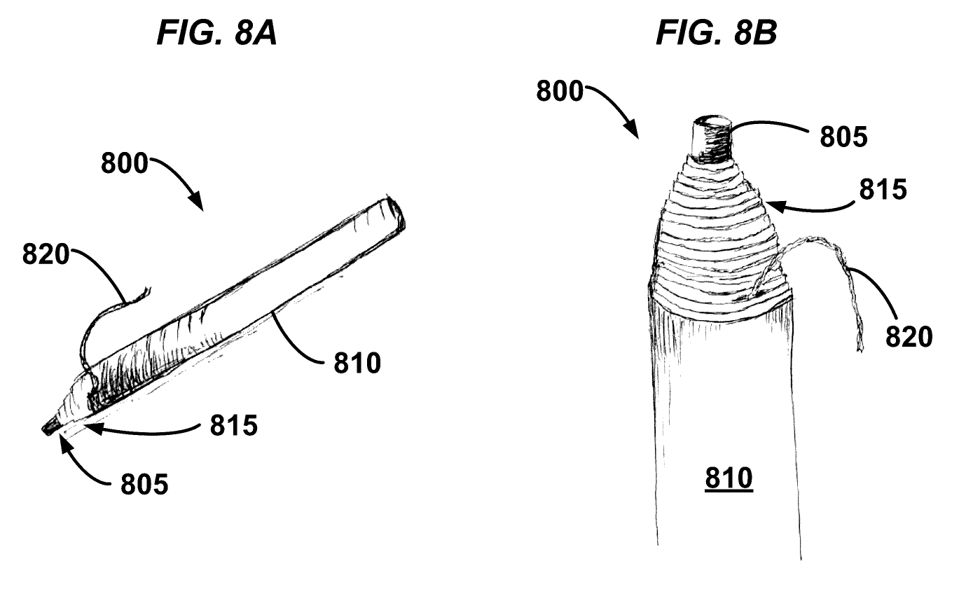

FIG. 4 depicts a final molded part 400 in accordance with some embodiments described herein. Like the final molded part 100 shown in FIG. 1, the final molded part 400 can have a non-uniform surface pattern to achieve a clustered (e.g., camouflage) appearance. For example, as shown, area 405 was formed with red molding materials in a first bag, area 410 was formed by green molding materials in a second bag, and area 415 was formed by yellow molding materials in a third bag. In addition, one or more twigs 420 may be formed to resemble sticks, twigs, and other debris. The twigs 420 may be formed prior to placing the bags in the mold by placing a spreadable material (e.g., a putty or paint) on the inner wall of the mold. This spreading material can be pulled across the inner wall of the mold, thereby leaving a color streak on the surface of the final molded part 400 to create the desired look. In other embodiments, wet paint is the spreadable material, and the paint may be applied to the inner wall of the mold, which is then transferred to the final molded part 400 during the molding process. To apply the spreadable material, stencils, computer aided graphics, and/or other insertable graphics may be used to assist in creating the desired look. In further embodiments, the spreadable material may be applied in pencil form, such as with a putty pencil 800 as shown in FIGS. 8A and 8B. Other bags with molding materials may also be used. As can be seen, when the bags give way, the molding materials are deposited on the inner wall of the mold behind the twigs 420, and the molding materials interact to form a non-uniform surface pattern. The molding materials combined with the twigs 420 may provide a desired clustered (e.g., camouflage) appearance.

In process, items that resemble branches, twigs, and the like may first be created on the inner wall of the mold. To do this, in some embodiments, putty may be spread on the inner wall of the mold. The putty may come in a variety of colors, as desired. Alternatively, in other embodiments, paint may be applied on the inner wall of the mold using a stencil or free hand. The paint may also come in a variety of colors. When the mold is heated, the putty or paint may transfer to the surface of the final molded part.

After creating the branches or twigs, the molding materials must be prepared. A bag material is selected based on the melt temperature and compatibility with the molding materials. The bag(s) may then be sized and shaped as needed for the final design. For example, leaf-shaped bags may be used with certain colors (e.g., red, yellow, orange, green), while round or rectangular bags may be used with background colors. Each bag may contain a single color or a combination of colors, as selected based on the desired final design.

The disclosed putty pencil 800 configured to apply the spreadable material to the inner wall of the mold can take on a variety of forms. In one embodiment, as shown in FIG. 8A, the putty pencil 800 may include a writing tip 805 and a body 810. The body 810 may form a hollow chamber that houses the spreadable material (e.g., putty or paint), and allows a user to grip the putty pencil 800. In some embodiments, the putty pencil 800 may be configured for right-handed or left-handed grip (or both). At least a portion of the body 810 may be covered by a removable material (e.g., paper, wax, thin plastic, etc.). To remove the material and expose the spreadable material, a string 820 wrapped around the putty pencil 800 underneath the material may be pulled. Shown as a tapered portion 815 in FIGS. 8A and 8B, a portion of the removable material has been removed from the putty pencil 800 via the string 820. This configuration permits use of the putty pencil 800 without the need for additional tools.

In another embodiment, the putty pencil 800 may have an outer casing constructed from wood, and be sharpened with a knife, file, or pencil sharpener like an ordinary pencil to expose the putty housed at the pencil's core. In other embodiments, the tapered portion 815 may include one or more tabs that allow layers or sections of the removable material to be removed without using the string 820. In such embodiments, the putty pencil 800 may not include a string 820. In further embodiments, the putty pencil 800 may be configured to mechanically drive forward the tip 805, thereby exposing a portion of the spreadable material housed within the body 810. It is contemplated that the putty pencil 800 may vary in size and shape based on the desired application and the size and shape of the mold. Further, the thickness of the spreadable material may vary based on the size of the desired markings.

In some embodiments, all of the molding materials are placed in bags, and the bags placed in the mold, at the outset of the molding process. In some embodiments, however, some molding materials are placed in bags, and other molding materials are not. Thus, the materials that are not placed in the bags can be placed in the mold around the bags such that they are free-flowing. In some embodiments, this can enable the free-flowing materials to form a background color on the final molded part.

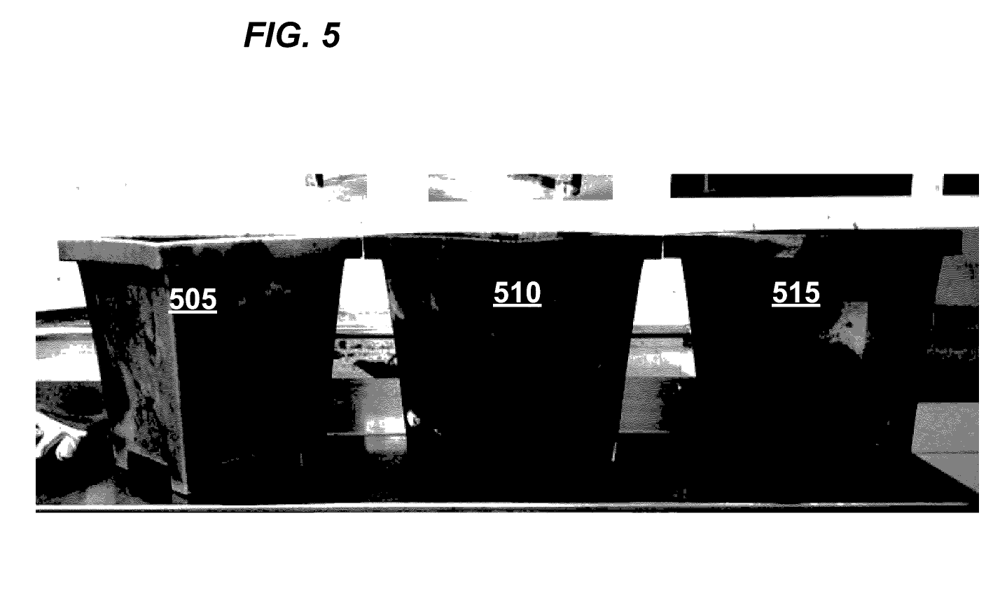

In some embodiments, it may be advantageous to create a three dimensional (“3D”) effect. To achieve this, transparent or semi-transparent molding materials may be placed in the mold either inside or outside (or both) of the bags. The molding materials are transparent or semi-transparent when they are at least partially transparent in the finished product. When placed outside of the bags, the transparent or semi-transparent molding materials may provide a more muted look than when placed inside of the bags. For example, as shown in FIG. 5, a part 505 was formed using the most molding material outside of bags, a part 510 was formed with a medium amount of molding material outside of bags, and a part 515 was formed without using molding material outside of bags. Further, in some embodiments, larger amounts of transparent or semi-transparent molding materials may be placed within the mold to achieve a greater 3D effect.

In some embodiments, the molding materials can be inserted into the mold, whether inside or outside of bags (or both), in multiple shots. For example, in one embodiment, a first shot of molding materials may be used to form a first layer having a clustered effect, while a second shot of transparent or semi-transparent molding materials may be later added and used to form a second layer for a 3D effect. In doing so, layers from additional shot(s) may be added without disturbing the clustered effect of the first, outer layer. Further, the additional layer(s) may provide a desired effect on the product, such as providing, for example, additional strength, foaming, or a solid color on the inside of the product (e.g., camouflage exterior and black interior). In another embodiment, the first shot may include transparent or semi-transparent molding materials to form a first layer, and the second shot may be used to form a second layer having a clustered effect, which can show through the transparent or semi-transparent first layer. Depending on the stage of the molding process, the added shots of molding materials may distribute and mix with the existing free-flowing materials within the mold.

It is contemplated that each shot may include different materials or forms of materials. For example, in one embodiment, the first shot may include free-flowing molding materials and the second shot may include bagged molding materials. In another exemplary embodiment, the first shot may include bagged molding materials and the second shot may include free-flowing molding materials. The additional shots of molding materials may be added to the mold, for example, manually or via a drop box.

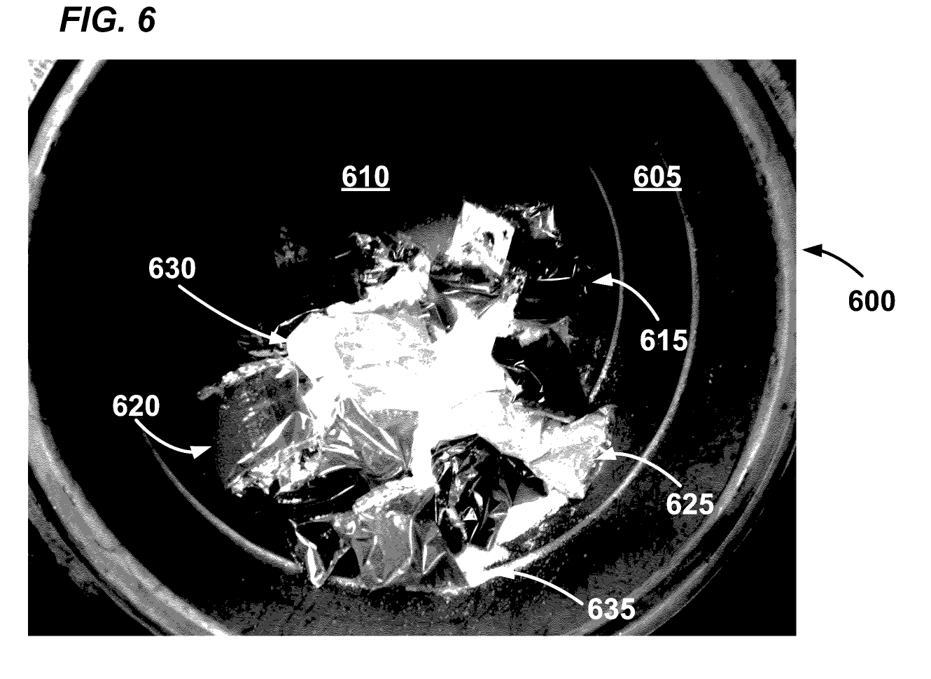

One exemplary embodiment of molding materials placed within a mold is shown in FIG. 6. As shown, a mold 600 may include an inner wall 605 and a bottom 610. Within the mold 600, the molding materials may include a plurality of bags containing blue molding materials 615, red molding materials 620, orange molding materials 625, and white molding materials 630. Additionally, non-bagged white molding materials 635 may be included within the mold 700. The non-bagged white molding materials 635 may include pellets, powders, flakes, or any other free-flowing molding materials, or combination thereof, as described herein. As this mold heats up and rotates, the non-bagged white molding materials 635 may disperse throughout the mold, thereby diluting its concentration compared to the bagged molding materials. In contrast, the bagged blue molding materials 615 may form a cluster on the inner wall 605 and/or the bottom 610 once its bag melts and it contacts the hot inner wall 605 or bottom 610. Similarly, the bagged red, orange, and white molding materials 620, 625, and 630 may each form a cluster on the inner wall 705 and/or the bottom 710 upon contacting the hot inner wall 605 or bottom 610. The resulting molded part may have a surface pattern with independent blue, red, orange, and white clusters, as well as mixed multi-colored areas. The rotation speed of the mold 600 may affect how the various colors mix together. That is, at higher rotation speeds, the mixed areas may comprise all of the available colors. In contrast, at lower rotation speeds, some of the mixed areas may primarily comprise non-bagged white molding materials 735 or combinations of only two or three colors.

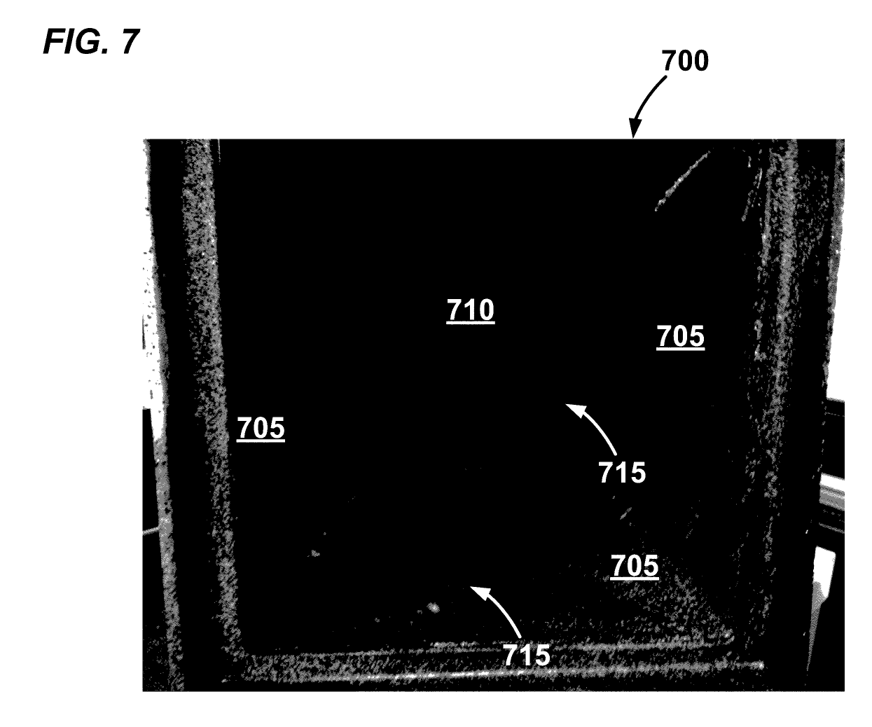

In some embodiments, the disclosed method may produce an article having an outer surface having a clustered effect similar to those shown in FIGS. 1, 4, and 5. The inner surface of the same article may have a uniformly distributed color and/or material as the molding materials continue to mix away from the inner wall of the mold. FIG. 7 shows an article 700 manufactured in accordance with one or more disclosed embodiments. Article 700 may include inner walls 705 and a bottom 710 each comprising a variety of colors (e.g., yellow, orange, brown, red, and black). When the molding materials are not evenly distributed within the mold to form an article having a uniform thickness and a smooth inner surface, clumps 715 formed by one or more clusters of molding materials may appear on the inner surface of the article 700.

It will be appreciated by those skilled in the art that the invention can be embodied in other specific forms without departing from the spirit or essential characteristics thereof. For example, while the invention has been described in the context of rotational molding with various materials that are initially contained in bags, the concepts described herein need not be limited to these illustrative embodiments. For example, the concepts described herein can be equally applicable to other types of molding, or to other types of containers to initially contain the molded materials.

Additionally, the specific configurations, choice of materials, and the size and shape of various elements could be varied according to particular design specifications or constraints according to the materials used and the manufacturing conditions. Such changes are intended to be embraced within the scope of the invention.

The presently disclosed embodiments are, therefore, considered in all respects to be illustrative and not restrictive. The scope of the invention is indicated by the appended claims, rather than the foregoing description, and all changes that come within the meaning and range of equivalents thereof are intended to be embraced therein.

What is claimed is:

1. A method of rotational molding comprising:
providing one or more first bags in a mold, the one or more first bags containing at least a first molding material;
providing one or more second bags in a mold, the one or more second bags containing at least a second molding material, the first and second molding materials each having a different visual material property; and
melting, as the mold rotates, the one or more first bags and the one or more second bags to release the first molding material from the one or more first bags and the second molding material from the one or more second bags.

2. The method of claim 1, further comprising:
causing a first portion of the released first molding material to adhere to an inner wall of the mold proximate a first immediate release area of the first molding material from the one or more first bags;
causing a first portion of the released second molding material to adhere to the inner wall of the mold proximate a second immediate release area of the second molding material from the one or more second bags; and
causing a second portion of the released first molding material and a second portion of the released second molding material to mix before adhering to another area of the inner wall of the mold to achieve a non-uniform surface pattern in the resulting molded part.

3. The method of claim 2, wherein the one or more first bags comprises a first bag having a first inner void shape and a second bag having a second inner void shape different than the first inner void shape, at least one of the first and second inner void shapes being based on the non-uniform surface pattern in the resulting molded part.

4. The method of claim 1 further comprising providing at least a third molding material in the mold, the first, second, and third molding materials each having a different visual material property.

5. The method of claim 4 further comprising:
causing a first portion of the released first molding material to adhere to an inner wall of the mold proximate a first immediate release area of the first molding material from the one or more first bags;
causing a first portion of the released second molding material to adhere to the inner wall of the mold proximate a second immediate release area of the second molding material from the one or more second bags; and
causing a second portion of the released first molding material and a second portion of the released second molding material to mix with at least a portion of the third molding material before adhering to another area of the inner wall of the mold to achieve a non-uniform surface pattern in the resulting molded part.

6. The method of claim 4, wherein providing the third molding material in the mold comprises providing one or more third bags containing the third molding material in the mold.

7. The method of claim 4, wherein the first and second molding materials comprises one or more of pellets and micropellets, and the third molding material comprises one or more of powders, flakes, shavings, pellets, micropellets, and clusters.

8. The method of claim 4, wherein providing the third molding material in the mold comprises depositing the third molding material in the mold after the first portion of the released first molding material adheres to the inner wall of the mold proximate the first immediate release area.

9. The method of claim 1, wherein the first molding material has a first visual material property and the second molding material has a second visual material property differing from the first material property.

10. The method of claim 9, wherein the first visual material property comprises one or more of a first color and a first degree of transparency and the second visual material property comprises one or more of a second color and a second degree of transparency.

11. The method of claim 2 further comprising:
rotating the mold at a first rotational speed before the first portion of the released first molding material adheres to the first immediate release area of the inner wall of the mold; and
rotating the mold at a second rotational speed after the first portion of the released first molding material adheres to the first immediate release area of the inner wall of the mold.

12. The method of claim 1 further comprising:
measuring a mold temperature within the mold;
determining when the measured mold temperature exceeds a predetermined temperature threshold; and
adjusting a rotational speed of the mold based on the determination.

13. The method of claim 1 further comprising:
determining when a molding process duration exceeds a predetermined time threshold;
adjusting a rotational speed of the mold based on the determination.

14. The method of claim 1 further comprising providing one or more mixed bags in the mold, the one or more mixed bags containing at least the first molding material and the second molding material.

15. The method of claim 1, wherein the one or more first bags comprises a first bag having a first size and a second bag having a second size different than the first size.

16. The method of claim 1, wherein providing the one or more first bags in a mold further comprises attaching a first bag of the one or more first bags to a second bag of the one or more first bags and providing the attached first and second bags in the mold.

17. The method of claim 1, wherein at least one of the one or more first bags is perforated.

18. The method of claim 1 further comprising one or more of directing a fluid into at least one of the one or more first bags before providing the one or more first bags in the mold, and suctioning a fluid from at least one of the one or more first bags before providing the one or more first bags in the mold.

19. A molded part formed by the method of claim 1.

20. The molded part of claim 19, wherein the molded part comprises an outermost layer having a non-uniform surface pattern with one or more concentrated areas of the first molding material, one or more concentrated areas of the second molding material, and one or more mixed areas of at least the first molding material and the second molding material, the first and second molding materials each having a different visual material property.

21. A method of rotational molding comprising:
providing one or more first bags in a mold, the one or more first bags containing at least a first molding material, the first molding material having a first visual material property;
providing one or more second bags in a mold, the one or more second bags containing at least a second molding material in the mold, the second molding material having a second visual material property differing from the first visual material property of the first molding material;
melting, as the mold rotates, the one or more first bags to release the first molding material from the one or more first bags;
determining when at least one of the one or more first bags and the one or more second bags have melted; and
adjusting a rotational speed of the mold based on the determination.

22. The molding system of claim 21, wherein the first visual material property comprises one or more of a first color and a first degree of transparency, and the second visual material property comprises one or more of a second color and a second degree of transparency.

23. A method of rotational molding comprising:
applying a spreadable material to an inner wall of a mold, the spreadable material being configured to transfer to the surface of a final molded part when the mold is heated;
providing one or more first bags in the mold, the one or more first bags containing at least a first molding material;
providing one or more second bags in a mold, the one or more second bags containing at least a second molding material, the first and second molding materials each having a different visual material property; and
melting, as the mold rotates, the one or more first bags and the one or more second bags to release the first molding material from the one or more first bags and the second molding material from the one or more second bags.

24. The method of claim 23, wherein applying the spreadable material to the inner wall of the mold comprises providing the spreadable material to the inner wall of the mold via a spreadable material instrument.
